(19) United States
(12) Patent Application Publication
(10) Pub. No.: US 2010/0103773 A1
(43) Pub. Date: Apr. 29, 2010

(54) Simultaneous Multiple Source Extended Inversion

(75) Inventors: Stephen K. CHIU, Katy, TX (US); Joel D. BREWER, Houston, TX (US); Peter M. EICK, Houston, TX (US); Charles W. EMMONS, Houston, TX (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 12/606,867

(22) Filed: Oct. 27, 2009

Related U.S. Application Data
(60) Provisional application No. 61/109,329, filed on Oct. 29, 2008.

(51) Int. Cl. G01V 1/36

(52) U.S. Cl. 367/41

(57) ABSTRACT

Methods for improving the range and resolution of simultaneous multiple vibratory source seismic system including ZENSEIS™ are provided.

### PRIOR RELATED APPLICATIONS

This application is a non-provisional application which claims benefit under 35 USC §119(e) to U.S. Provisional Application Ser. No. 61/109,329 filed Oct. 29, 2008, entitled “SIMULTANEOUS MULTIPLE SOURCE EXTENDED INVERSION,” which is incorporated herein in its entirety.

### FIELD OF THE DISCLOSURE

The present disclosure generally relates to methods and apparatus for improving the range and resolution of simultaneous multiple vibratory source seismic system (ZENSEIS™). The depth of investigation is beyond the traditional listening time.

### BACKGROUND OF THE DISCLOSURE

Seismic explorations using vibratory sources have been used successfully for decades. Vibroseis is a method that sends a sinusoidal signal with continuously varying frequency to the ground over a specific time period. The duration of the sinusoidal signal or a sweep length spreads out many seconds. The designs of the sweep length and listening time are two important components for the success in meeting exploration objectives. Since the combination of the sweep length and listening time is over many seconds and a typical range of values are from 10 to 30 seconds, the uncorrelated field data is usually processed in the field to extract a specific length of a seismic record that is normally equal to the listening time. The uncorrelated field data is no longer available after field processing to minimize data storage.

Intrinsic earth attenuation plays a key factor in determining the data bandwidth of the vibroseis data. As seismic energy propagates through subsurface rocks, high frequencies are naturally attenuated faster than low frequencies. By increasing recording time, higher frequency contents of the signal are reduced.

Cross correlation method is a standard technique to extract seismic signals from recorded data that are acquired by vibratory sources. It is a measure of similarity of the embedded sweep signal and the recorded data. Cross correlation extracts the signals that are common to both the recorded data and embedded sweep. Okaya (1986) used an extended correlation to extract additional vibroseis data beyond the listening time. Okaya and Jarchow (1989) provided an excellent description of extended correlation for a self-truncating extended correlation where a correlation operator rolls past the uncorrelated data; the portion of the correlated data past the end of recorded field data does not have complete sweeps preserved due to the loss of high frequency data. Extended correlation has been used to map deeper crustal structures. Unfortunately Okaya's extended correlation method is only valid for a single source or multiple sources that have exactly the same waveform. However, the correlation method fails to extract signals from simultaneous multiple sources.

A method of retrieving additional data that is beyond conventional listening time using extended simultaneous multiple source inversion. This method provides an extended depth of investigation with no additional acquisition cost.

### BRIEF DESCRIPTION OF THE DISCLOSURE

The concept of a self-truncating extended correlation is also applicable to simultaneous multiple source data. Simultaneous multiple source data recorded with a listening time are used to reconstruct data that extends the depth of investigation beyond the listening time. The data recorded within a given listening time, ‘bandlimited recorded data’, composes of signal bandwidth that varies as a function of recording time or varies as the depth of wave propagation For the case of upsweep operations, the reconstructed data that are beyond the listening time lose some high frequencies due to the lack of high-frequency content of the recorded data; for the case of downsweep operations, the reconstructed data that are beyond the listening time lose some low frequencies due to the lack of low-frequency content of the recorded data. Synthetic simulations and a real data example illustrate the success of this new method of extracting additional data with little additional cost, and also demonstrate that the frequency loss due to the extended inversion is not an issue for typical seismic explorations.

Methods of reducing the number of multiple seismic sweeps for a seismic survey by processing simultaneous multiple source seismic data with an extended output record length greater than the listening time used to acquire the input data; and inverting the input data to generate a separated source data, thus the data image a geological feature with fewer seismic sweeps than required when analyzed over total listening time without an extended output record length.

As defined herein extended simultaneous multiple source inversion is an inversion to separate field data into proper source gathers. In vibroseis the seismic energy source is distributed over a period of time. This distribution of energy over time creates a distinct signal, such as a sweep, in which the signal changes systematically from low frequency at the beginning to high frequency at the end of the source. Dependent upon the desired signal, number of vibroseis being conducted simultaneously, and transmission properties of the ground, different seismic sweeps may be developed. Computer processing of the seismic signals uses the distinct characteristics of the sweep to “collapse” the energy into short duration wavelets. ZENSEIS™ sources include vibroseis, seismic vibrator, and combinations thereof. Other multiple source seismic surveys include high fidelity vibratory seismic (HFVS), cascaded HFVS, combined HFVS, slipsweep, and the like.

“Simultaneous” sweeps are conducted by two or more seismic sources during overlapping periods of time. In contrast, synchronous sweeps are conducted by two or more seismic sources started and stopped at the same time. Using a starting pulse signal, computer control, or other coordinated methods, synchronized vibrators on a seismic survey may be started within milliseconds to generate a synchronous seismic signal. During synchronous seismic surveys the source vibrator frequency, phase, amplitude, and the like, may be synchronized to reduce interference, enhance signal, or otherwise enhance or modify the recorded data. Using a “simultaneous” sweep the source signals may have a “lag” either by design or unintentionally. In one embodiment, source signals are intentionally designed with a lag from 1 ms to 10 seconds wherein the lag allows independent signal encoding. In another embodiment, seismic sources are given one or more positions and time window but are operated independently. When the seismic sources are operated independently an arbitrary lag is created due to the asynchronous (or random) operation of the sources.

As defined herein extension of output record length can be increased to the entire sweep length. In one embodiment the output record length can be increased by approximately 100, 150, 200, 250, 350, 500, 750, 999 milliseconds. In a preferred embodiment the output record length can be increased by approximately 1, 1.5, 2, 3, 4, 5, 6, 7, 8, 9, or 10 seconds. The length of the extension in output record length is irrelevant as long as it exceeds the time of interest in the seismic survey. For example, a feature of interest at 4.6 seconds can be shown by extending the output data to 6 seconds, 5.2 seconds, or 4.7 seconds, but not 4.5 seconds.

“Approximately” as defined herein is less than 20%, preferably less than 10%, most preferably less than 5% variation. For extension of output data, the data may extend beyond the point of interest and in general is increased sufficiently to exceed any geological features by milliseconds or seconds depending on the size, shape and proximity of the feature.

Processing simultaneous multiple source seismic data by selecting an output time greater than the listening time used to acquire the input data; increasing output record length; inverting the input data to separate source data; and generating separated data with an output time greater than listening time.

Reducing multiple seismic sweeps for a seismic survey by processing simultaneous multiple source seismic data with an extended output record length greater than the listening time used to acquire the input data; and inverting the input data to generate a separated source data, thus the data image a geological feature with fewer seismic sweeps than required when analyzed over total listening time without an extended output record length.

The frequency (f) of the separated data greater than listening time is proportional to (f₁−(f₁−f₀)/t_{sweep}) (t−tₗᵢₛₜₑₙ) for extended data. The output record length can be increased to the entire sweep length, for example by approximately 1, 2, 3, 4, 5, 6, 7, 8, 9, or 10 seconds, or by approximately 5%, 10%, 15%, 20%, 25%, 30%, 35%, 40%, 45%, 50%, 55%, 60%, 65%, 70%, 75%, 80%, 85%, 90%, 95%, or 100% of the listening or sweep time. The data may be discrete sweeps or continuous with multiple sources and multiple sweeps overlapping for a period of seconds, minutes, hours or days.

### BRIEF DESCRIPTION OF THE DRAWINGS

FIG. 1: Extended simultaneous multiple source inversion data processing flowchart.

FIG. 2: Synthetic example of extended simultaneous multiple source inversion. Sweep frequency 5-100 Hz with 16 sec sweep length and 4 sec listening time. Ideal seismic model used to generate synthetic data (A). Raw synthetic data generated by convolving 4 simultaneous vibratory sweeps with seismic model (B). Comparison of ideal seismic model, inverted data with 4 second output data length, and inverted data with 6 second output data length (C). An expanded portion of (C) to demonstrate that additional data can be recovered using extended simultaneous multiple source inversion (D).

FIG. 3: Synthetic example of extended simultaneous multiple source inversion. Sweep frequency 5-100 Hz with 8 sec sweep length and 4 sec listening time. The decrease of sweep length further reduces the bandwidth of the extended data. Ideal seismic model used to generate synthetic data (A). Comparison of ideal seismic model, inverted data with 4 second output data length, and inverted data with 6 second output data length (B). An expanded portion of (B) to demonstrate that additional data can be recovered using extended simultaneous multiple source inversion (C).

FIG. 4: Amplitude spectra: full vs. partial bandwidth. Amplitude spectra are computed from FIG. 2C. The ideal spectra (A) obtained at a data window between 1.5 to 2.0 seconds shows amplitude from 0-120 Hz. The amplitude spectra of the inverted data with 6 second output (B) and the 4 second output (C) are identical. The decrease amplitude above 100 Hz is due to frequency limit of the sweep. However, the amplitude spectrum of the extended data (D) has decreased from 100 to about 88 Hz. As the second example, amplitude spectra are computed from FIG. 3B. Panel E, F, G, and H show a similar trend with decreased amplitude for the extended data above approximately 80 Hz.

FIG. 5: Shot records for airwaves (A), surface waves (B), and reflections (C & D). Data are captured from a variety of conditions, additional 2 second extended data are shown in black boxes from 4-6 seconds.

FIG. 6: Inline stack examples to show geological features (A) and (C). The Extended data are shown in black boxes from 4-6 seconds. (B) and (D) are expanded portion of (A) and (C) to show how the extended data reconstruct geological structures beyond the listening time.

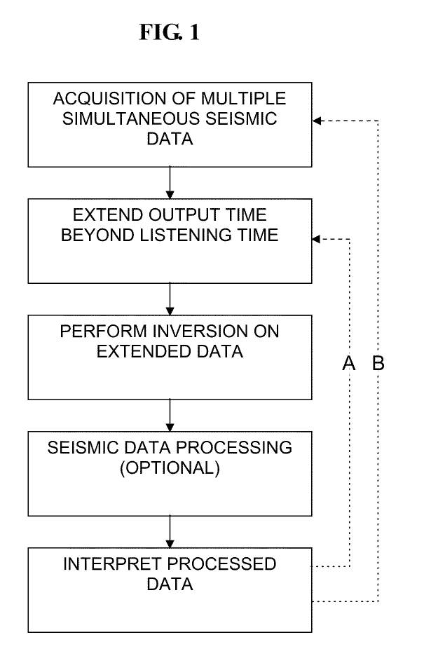

### DETAILED DESCRIPTION OF EMBODIMENTS OF THE INVENTION

The nature of long sinusoidal vibroseis signals allows truncated vibratory sweeps to extract additional ZENSEIS™ data that is beyond a listening time with little additional cost. A new method that is similar to the concept of a self-truncating vibroseis extended correlation uses an inversion instead of a cross-correlation process to reconstruct extended ZENSEIS™ data. It produces exactly the same data as the traditional ZENSEIS™ data if the output time after the inversion is equal to the traditional ZENSEIS™ listening time. If the output time after the inversion is greater than the traditional ZENSEIS™ listening time, the bandlimited recorded data that produce the extended data also reduce the data bandwidth. Fortunately, the frequency loss due to the intrinsic-earth attenuation usually decays faster than the bandlimited recorded data. The bandwidth of the extended data is often well above the data bandwidth required for seismic explorations. In general, the reduction of sweep bandwidth is not an issue for typical seismic explorations and the use of bandlimited recorded data typically reconstructs geological structures extremely well. We demonstrate the effectiveness of this method with synthetic and real data.

Previously in U.S. Pat. No. 7,295,490, methods to improve seismic acquisition and the quality of seismic data were described that use seismic processing, analysis and/or acquisition designed to allow the best phase encoding schemes to yield better quality ZENSEIS™ survey by providing source signals with superior properties. US20080137476 describes constellations of vibroseis sources queued for continuous recording of ZENSEIS™ data. Additionally, U.S. application Ser. No. 11/855,776 describes noise attenuation algorithms to reduce background noise prior to source separation. U.S. application Ser. No. 11/933,522 uses a variety of systems to minimize interference between seismic sources. Application 61/109,403 filed Oct. 29, 2008, describes a marine vibroseis system. Finally, U.S. Application 61/109,279 filed Oct. 29, 2008, describes synchronizing sources and receivers with a vibroseis system. These prior patents and applications are incorporated by reference.

The simultaneous multiple source extended inversion (SIMSEI) uses a similar concept of the self-truncating extended correlation (Okaya, 1989) to extract additional data. It replaces a cross-correlation process by an inversion process to separate field data into proper source gathers (Chiu et al., 2005). If the output time after source separation is equal to listening time, the SIMSEI produces data with a full bandwidth of the sweep. However, if the output time after source separation is greater than the listening time, the SIMSEI produces data with a partial bandwidth of the sweep.

The reduced maximum frequency of the extended data due to the bandlimited recorded data is:

$$\begin{matrix}{f}_{max} ( t ) = {f}_{1} & 0 \leq t \leq {t}_{output} \\ = {f}_{1} - \frac{{f}_{1} - {f}_{0}}{{t}_{sweep}} ( t - {t}_{listen} ) & {t}_{listen} < t \leq {t}_{output}\end{matrix} \qquad ( 1 )$$

where f₀ and f₁ are starting and ending frequency. t_{sweep}, tₗᵢₛₜₑₙ, and tₒᵤₜₚᵤₜ are sweep length, listening and output time. Below Table 1 shows an example how the frequency decreases as a function of the extended time. In this example, the starting and ending frequencies of the sweep are 8 and 100 Hz, and the sweep length is 16 seconds.

TABLE 1
Frequency decrease over extended time

| fₘₐₓ | tₗᵢₛₜₑₙ | tₒᵤₜₚᵤₜ | T_{extend} |
|---|---|---|---|
| HZ | sec | sec | sec |
| 100 | 2 | 2 | 0 |
| 88 | 2 | 4 | 2 |
| 77 | 2 | 6 | 4 |

For example, the additional 2-second output only reduces the maximum sweep frequency from 100 to 88 Hz. This loss of high frequencies due to the bandlimited recorded data is still above the data bandwidth required for a typical seismic exploration. This indicates that the frequency loss due to the bandlimited recorded data will not affect typical seismic visualizations and will not decrease resolution or quality of a seismic assay.

The present invention will be better understood with reference to the following non-limiting examples.

### EXAMPLE 1

### Ideal Model

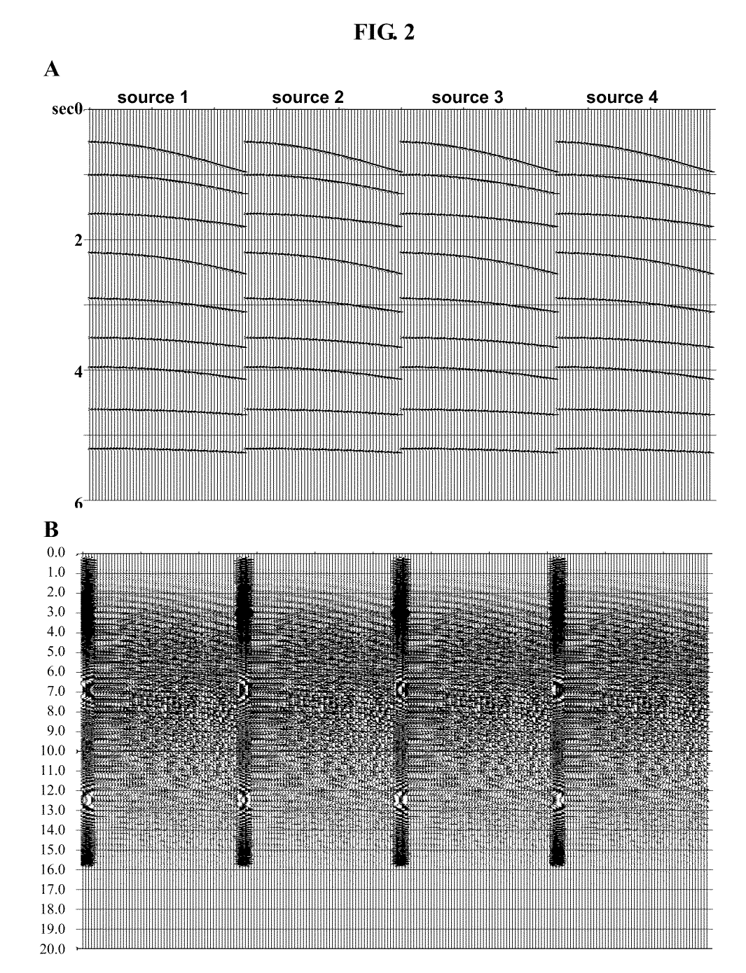

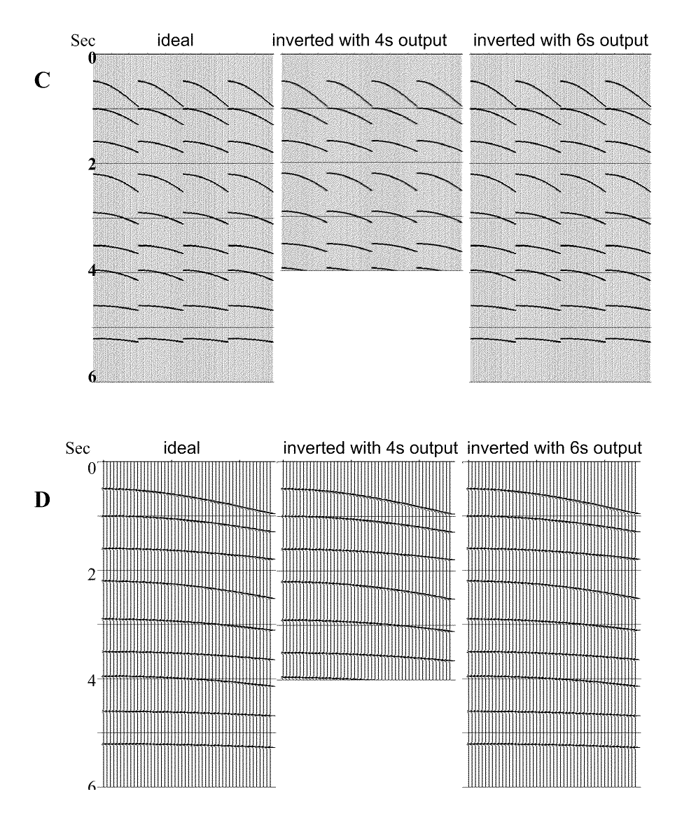

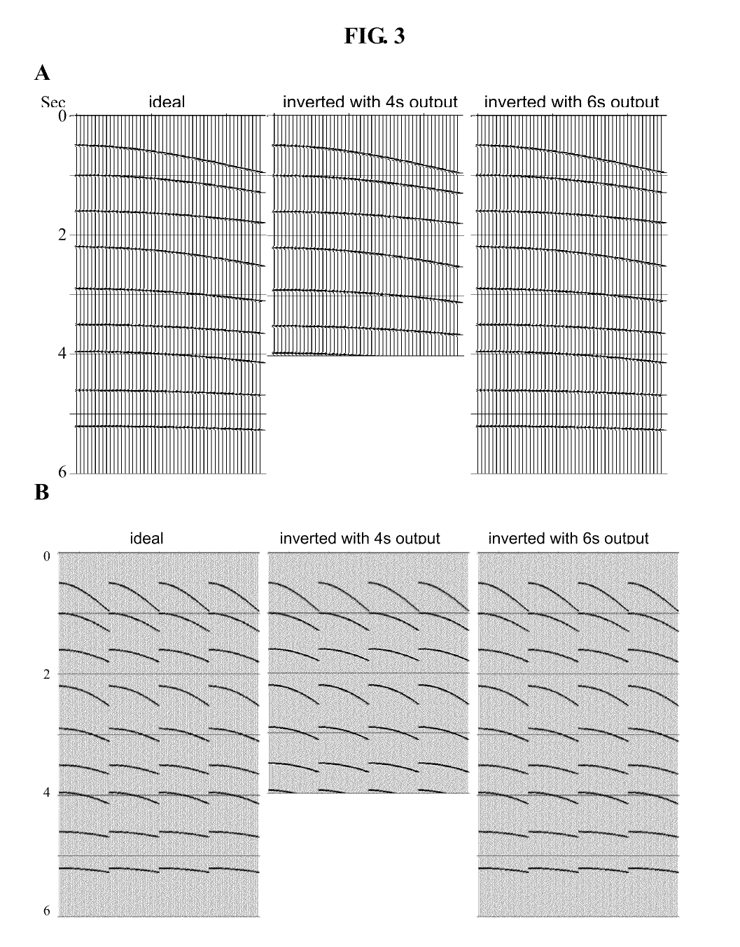

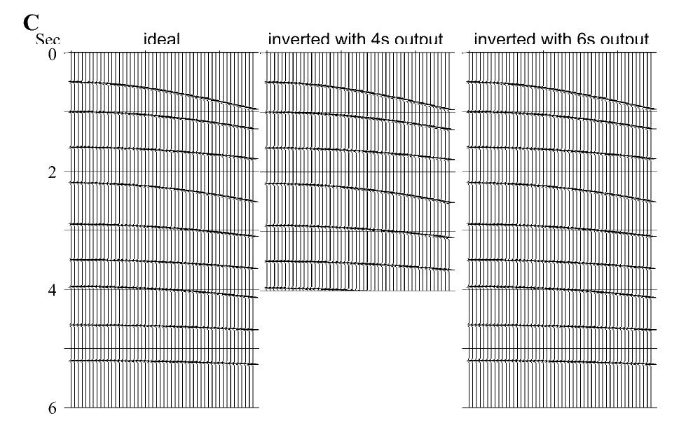

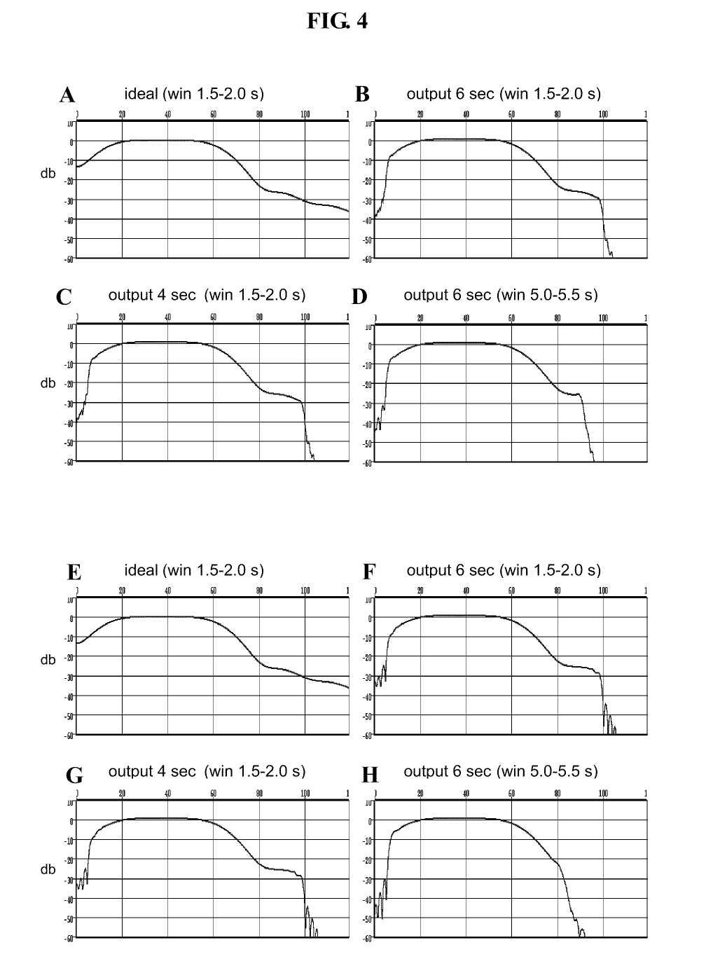

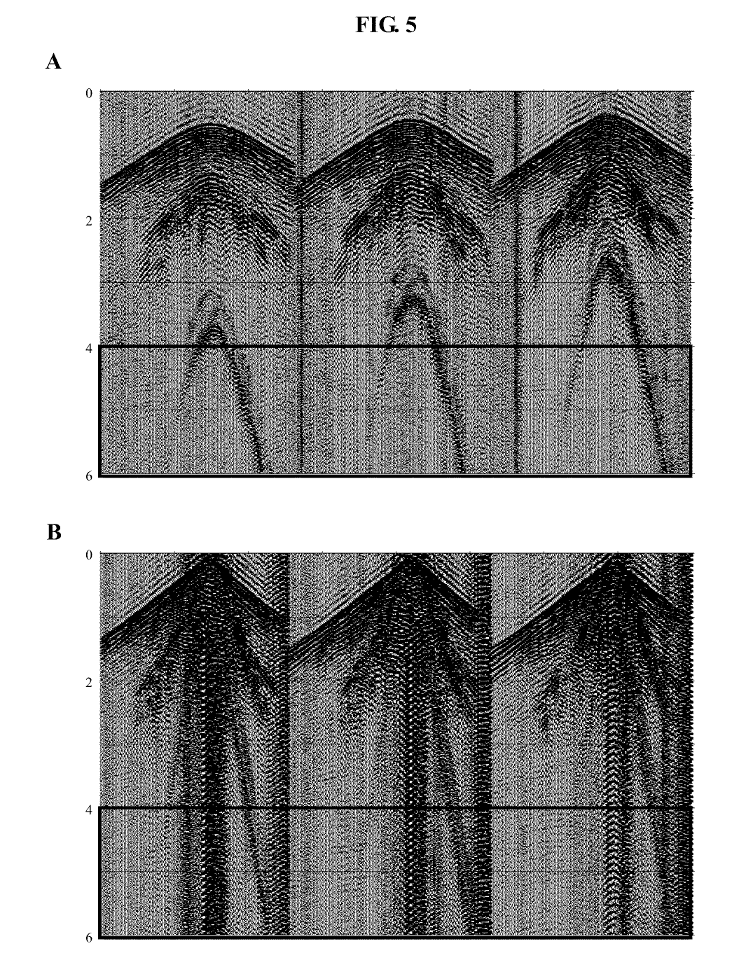

We first demonstrate the effectiveness of this method with two synthetic data sets. The geometry of this synthetic consists of four vibratory sources. For the first synthetic data, the sweep frequency is from 5 to 100 Hz with a 16-second sweep length and a 4-second listening time. The designed output time after source separation is 4 seconds that is equal to the listening time. The SIMSEI creates additional 2 seconds of data that is beyond the 4 seconds of the listening time. The inverted data are identical between the original 4-second output and extended output. The extended output also matches the ideal response extremely well (FIG. 2 A-D). This confirms that the extended inversion that uses bandlimited recorded data can reproduce the desired events between 4 and 6 seconds. As a second example, the sweep length changes from 16 seconds to 8 seconds to demonstrate further loss of data bandwidth due to a shorter sweep (FIG. 3 A-C). We can draw a similar conclusion as the first example: The extended output also matches the ideal response extremely well. The ideal signal has frequency up to 120 Hz (FIGS. 4A & E). After the source separation, the sweep frequency reduces the signal frequency up to 100 Hz. For both cases, the bandwidth is identical at a window of 1.5 to 2.0 seconds between the extended 6-second output and original 4-second output (FIGS. 4 B & C, and F & G). This reconfirms that the extended inversion reproduces the same output as the original 4-second output. However, for the extended data in both cases (FIGS. 4D & H), the frequency loss due to the bandlimited recorded data is about 12 Hz and 23 Hz respectively. This matches the frequency loss predicted by equation 1 quite well.

### EXAMPLE 2

### 3D Land Survey

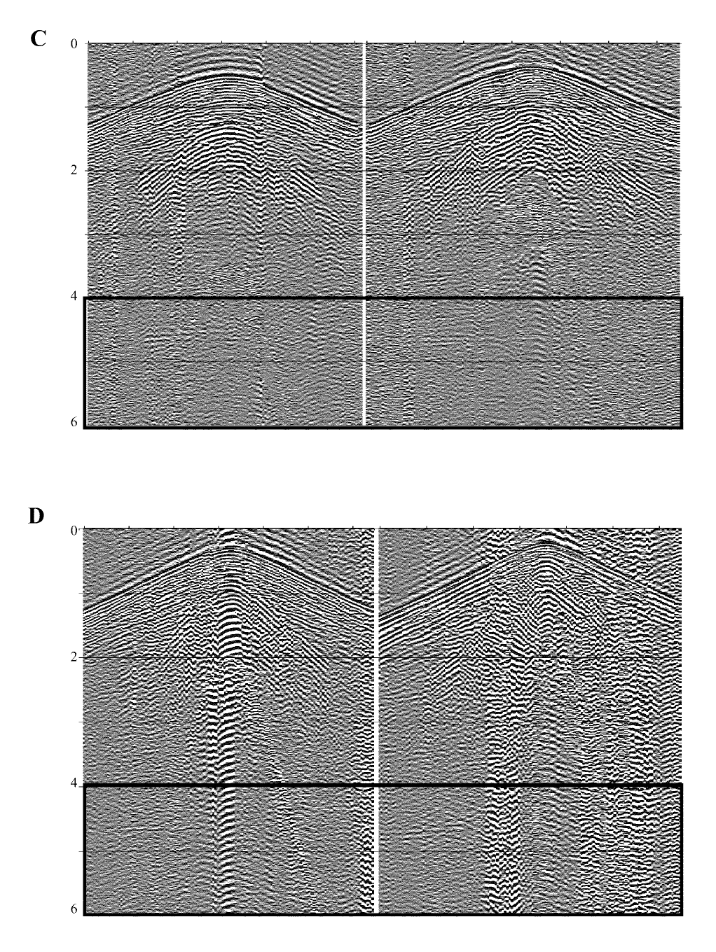

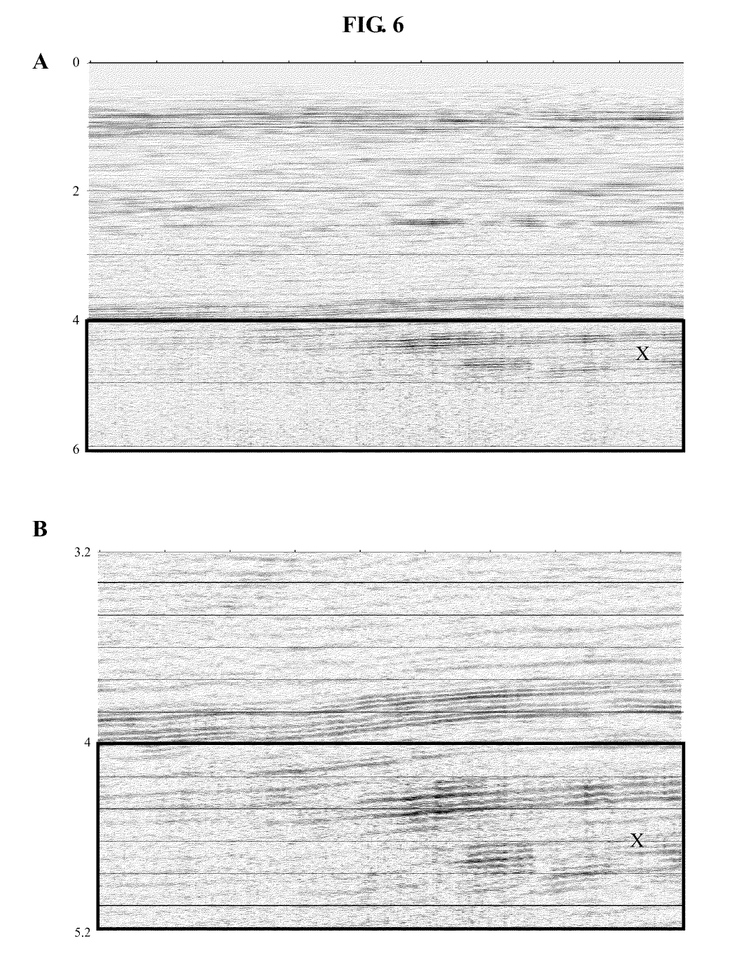

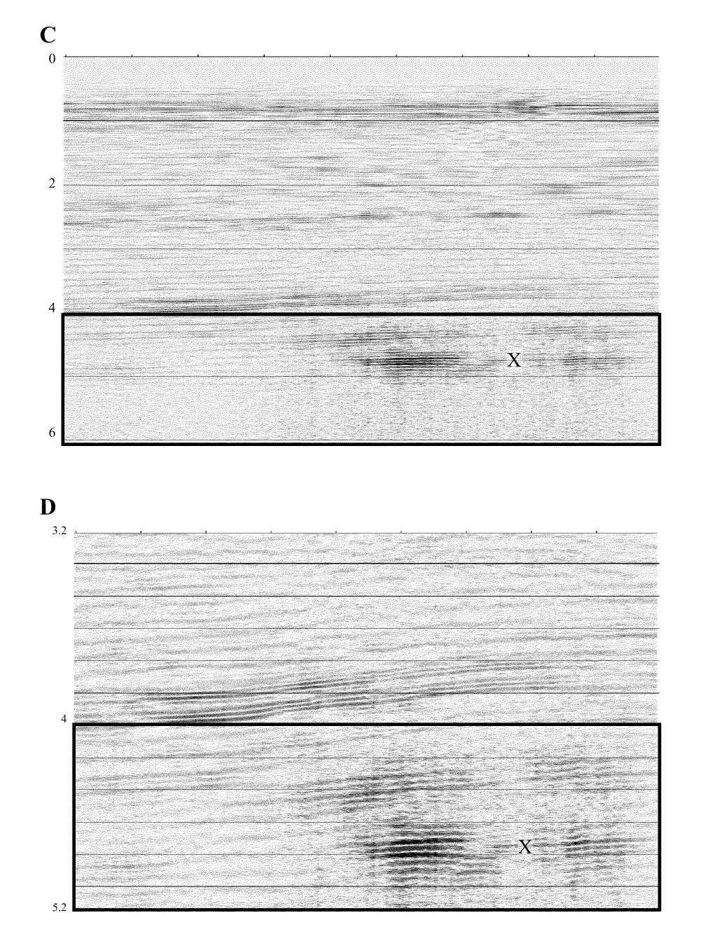

This method was applied to a 3D land data set. The acquisition geometry used four vibratory sources with a sweep frequency from 8 to 96 Hz, a 24-second sweep length, and a 4-second listening time. The original output time after source separation is 4 seconds thus a 4 second listening time. After a preliminary processing, 3D stack shows that there are interesting geological structures that are truncated at the end of 4-second data. The objective is to use SIMSEI to extract additional 2 seconds of data to explore the truncated structures. As shown in FIG. 5A-D, the SIMSEI can be used to reconstruct ground roll, air waves, and reflected events and the extended data outlined in black. Note the continuation of ground roll and air waves between 2 to 6 seconds. FIGS. 6A & C display two typical inline 3D stacks showing the truncated structures around 4 seconds. Extended inversion with additional 2 seconds of data (outlined in black) reveals the continuation of the structures below 4 seconds. The extended inversion regenerated a full dataset without a significant loss of resolution or accuracy. FIGS. 6B & D are expanded portion of FIGS. 6A & C to better illustrate the target structure (X). Additional features, not reported on the truncated dataset are shown in detail using the extended inversion technique.

SIMSEI is an effective tool for extraction of additional data beyond the listening time without a significant increase in cost. SIMSEI can be used under a variety of conditions to reproduce traditional ZENSEIS™ data along with “extended” data increasing resolution and depth of investigation. Synthetic and real data examples demonstrate that the use of bandlimited recorded data reconstructs geological structures extremely well, but with a decrease of data bandwidth. However, the frequency loss due to intrinsic-earth attenuation usually decays faster than the bandlimited recorded data; the bandwidth of the extended data is often well above the data bandwidth required for seismic explorations. The intrinsic-earth attenuation actually makes this method feasible to extract additional data.

Although the systems and processes described herein have been described in detail, it should be understood that various changes, substitutions, and alterations can be made without departing from the spirit and scope of the invention as defined by the following claims.

### REFERENCES

All of the references cited herein are expressly incorporated by reference. Incorporated references are listed again here for convenience:
1. U.S. Ser. No. 11/855,776 filed Sep. 14, 2007, Olson, et al., “Method and Apparatus for Pre-Inversion Noise Attenuation of Seismic Data.”
2. U.S. Ser. No. 11/933,522 filed Nov. 1, 2007, Chiu, et al., “Method and Apparatus for Minimizing Interference Between Seismic Systems.”
3. U.S. Ser. No. 12/167,683 filed Jul. 3, 2008, Brewer, et al., “Marine Seismic Acquisition with Controlled Streamer Flaring.”
4. U.S. Ser. No. 61/109,279 filed Oct. 29, 2008, Eick, et al., “Variable Timing ZENSEIS™.”
5. U.S. Ser. No. 61/109,329 filed Oct. 29, 2008, Chiu, et al., “Simultaneous Multiple Source Extended Inversion.”
6. U.S. Ser. No. 61/109,403 filed Oct. 29, 2008, Eick, et al., “Marine Seismic Acquisition.”
7. U.S. Ser. No. 61/112,810 filed Nov. 10, 2008, Brewer, et al., “4D Seismic Signal Analysis.”
8. U.S. Ser. No. 61/112,875 filed Nov. 10, 2008, Eick and Brewer, “Practical Autonomous Seismic Recorder Implementation and Use.”
9. U.S. Ser. No. 61/121,976 filed Dec. 12, 2008, Cramer et al., “Controlled Source Fracture Monitoring.”
10. U.S. Pat. No. 7,295,490, Chiu, et al. “System and Method of Phase Encoding for High Fidelity Vibratory Seismic Data.”
11. US20080137476, Eick, et al. “Dynamic Source Parameter Selection for Seismic Vibrator Data Acquisition.”
12. Chiu, S. K., Emmons, C. W., and Eick P. P., 2005, High Fidelity Vibratory Seismic (HFVS): robust inversion using generalized inverse: 75th Annual Internat. Mtg. Soc. Expl. Geophys. Expanded Abstracts, 1650-1653
13. Gurbuz, B. M., 2006, “Upsweep Signals with High-Frequency Attenuation and Their Use in the Construction of VIBROSEIS® Synthetic Seismograms” Geophysical Prospecting 30:432-443.
14. Okaya, D. A. and Jarchow C. M., 1989, Extraction of deep crustal reflections from shallow Vibroseis data using extended correlation, Geophysics 54, 555-561.
15. Okaya, D. A., 1986, “Seismic profiling of the lower crust: Dixie Valley, Nevada.” Barazangi, M., and Brown, L., Eds., Reflection seismology: the continental crust: Am. Geophys. Union, Geodyn. Ser. 14, 269-279.

We claim:

1. A method of processing simultaneous multiple source seismic data, said method comprising:
a) selecting an output time greater than a listening time used to acquire input data;
b) increasing output record length;
c) inverting said input data to separate source data; and
d) generating a separated data with an output time greater than listening time.

2. The method of claim 1, wherein the frequency (f) of the seismic data is greater than listening time proportional to (f₁−(f₁−f₀)t_{sweep}) (t−tₗᵢₛₜₑₙ) for extended data.

3. The method of claim 1, wherein said output record length is increased to sweep length.

4. The method of claim 1, wherein said output record length is increased by approximately 100, 150, 200, 250, 350, 500, 750, or 999 milliseconds or greater than 1 second up to sweep length.

5. The method of claim 1, wherein said output record length is increased by approximately 1, 1.5, 2, 3, 4, 5, 6, 7, 8, 9, or 10 seconds or greater than 10 seconds up to sweep length.

6. The method of claim 1, wherein said output record length is increased by approximately 5%, 10%, 15%, 20%, 25%, 30%, 35%, 40%, 45%, 50%, 55%, 60%, 65%, 70%, 75%, 80%, 85%, 90%, 95%, or 100% of the listening time.

7. The method of claim 1, wherein said output record length is increased by approximately 5%, 10%, 15%, 20%, 25%, 30%, 35%, 40%, 45%, 50%, 55%, 60%, 65%, 70%, 75%, 80%, 85%, 90%, 95%, or 100% of the sweep time.

8. The method of claim 1, wherein said data are continuous with multiple sources and multiple sweeps overlapping for a period of seconds, minutes, hours or days.

9. A method of reducing multiple seismic sweeps for a seismic survey comprising:
a) processing simultaneous multiple source seismic data with an extended output record length greater than a listening time used to acquire an input data; and
b) inverting said input data to generate separate source data,
wherein said data image a geological feature with fewer seismic sweeps than required when analyzed over total listening time without an extended output record length.

10. The method of claim 9, wherein the frequency (f) of the seismic data is greater than listening time proportional to (f₁−(f₁−f₀)/t_{sweep}) (t−tₗᵢₛₜₑₙ) for extended data.

11. The method of claim 9, wherein said output record length is increased to sweep length.

12. The method of claim 9, wherein said output record length is increased by approximately 100, 150, 200, 250, 350, 500, 750, or 999 milliseconds or greater than 1 second up to sweep length.

13. The method of claim 9, wherein said output record length is increased by approximately 1, 2, 3, 4, 5, 6, 7, 8, 9, 10 seconds or greater than 10 seconds up to sweep length.

14. The method of claim 9, wherein said output record length is increased by approximately 5%, 10%, 15%, 20%, 25%, 30%, 35%, 40%, 45%, 50%, 55%, 60%, 65%, 70%, 75%, 80%, 85%, 90%, 95%, or 100% of the listening time.

15. The method of claim 9, wherein said output record length is increased by approximately 5%, 10%, 15%, 20%, 25%, 30%, 35%, 40%, 45%, 50%, 55%, 60%, 65%, 70%, 75%, 80%, 85%, 90%, 95%, or 100% of the sweep time.

16. The method of claim 9, wherein said data are continuous with multiple sources and multiple sweeps overlapping for a period of seconds, minutes, hours or days.
